(19) United States
(12) Patent Application Publication
(10) Pub. No.: US 2023/0386343 A1
(43) Pub. Date: Nov. 30, 2023

(54) APPARATUSES, METHODS, AND SYSTEMS OF CONTROLLING VEHICLE PLATOONS

(71) Applicant: Cummins Inc., Columbus, IN (US)

(72) Inventors: Hoseinali Borhan, Bloomington, IN (US); Ardalan Vahidi, Clemson, SC (US); Tyler Reese Ard, Clemson, SC (US); Bibin N. Pattel, Columbus, IN (US)

(21) Appl. No.: 18/323,813

(22) Filed: May 25, 2023

Related U.S. Application Data
(60) Provisional application No. 63/365,334, filed on May 26, 2022.

(51) Int. Cl. G08G 1/00; B60W 30/165

(52) U.S. Cl. CPC G08G 1/22; B60W 30/165; B60W 2756/10

(57) ABSTRACT

A method of operating a platoon of vehicles may include determining a joint optimization of operating parameters of a forward vehicle of the platoon and a rearward vehicle of the platoon. The operating parameters of the forward vehicle may include vehicle motion plan parameters for the forward vehicle. The operating parameters of the rearward vehicle may include suggested control actions for the second vehicle. The method may include wirelessly transmitting from the forward vehicle the vehicle motion plan parameters for the forward vehicle and the suggested control actions for the rearward vehicle, wirelessly receiving at the forward vehicle following vehicle capability parameters indicating capability of the following vehicle, determining in response to the following vehicle capability parameters an updated joint optimization including updated vehicle motion plan parameters for the forward vehicle, and controlling motion of the forward vehicle in response to the updated vehicle motion plan parameters.

### CROSS REFERENCE

The present application claims priority to and the benefit of U.S. Application No. 63/365,334 filed May 26, 2022 which is hereby incorporated by reference.

### GOVERNMENT RIGHTS

This invention was made with government support under Award Number DE-EE0008469 awarded by the U.S. Department of Energy, Office of Energy Efficiency and Renewable Energy (EERE). The government has certain rights in the invention.

### TECHNICAL FIELD

The present disclosure relates to apparatuses, methods, systems, and techniques of controlling vehicle platoons and to apparatuses, methods, systems, and techniques of cooperative control and automation of vehicle platoons.

### BACKGROUND

A vehicle platoon (also sometimes referred to as a convoy) typically comprises a group of vehicles traveling in close proximity using RADAR, LIDAR, proximity sensor information, or camera information, and in some instances, inter-vehicle coordination facilitated by some form of direct or indirect (e.g., cloud-based) communication. Current proposals for controlling vehicle platoons, while recognizing some potential benefits, face a number of challenges and suffer from a number of drawbacks, limitations, and shortcomings including those respecting fuel efficiency and safety. Conventional connected and adaptive cruise control (CACC) systems have been proposed for automating operation of vehicle platoons or convoys, but have been unable to efficiently handle real-world road grade transients and velocity transients without the assistance of fleet operator intervention. Conventional approaches are further limited as they are non-adaptive to varied vehicle hardware and loading conditions. These and other shortcomings of conventional approaches have limited the ability to implement and utilize autonomous vehicle systems in connection with platooning operation. There remain a number of significant needs for the unique apparatuses, methods, systems, and techniques disclosed herein.

### DISCLOSURE OF ILLUSTRATIVE EMBODIMENTS

For the purposes of clearly, concisely, and exactly describing illustrative embodiments of the present disclosure, the manner and process of making and using the same, and to enable the practice, making and use of the same, reference will now be made to certain illustrative embodiments, including those illustrated in the figures, and specific language will be used to describe the same. It shall nevertheless be understood that no limitation of the scope of the invention is thereby created and that the invention includes and protects such alterations, modifications, and further applications of the illustrative embodiments as would occur to one skilled in the art.

### SUMMARY OF THE DISCLOSURE

Illustrative embodiments include unique apparatuses, methods, and systems of controlling vehicle platoons. Some forms include cooperative control of vehicle platoons. Some forms include automation of vehicle platoons. Further embodiments, forms, objects, features, advantages, aspects, and benefits shall become apparent from the following description and drawings.

### BRIEF DESCRIPTION OF THE DRAWINGS

FIG. 1 is a schematic illustration of certain aspects of an example vehicle platoon.

FIG. 2 is a schematic illustration of certain aspects of an example vehicle configured for platooning operation.

FIG. 3 is a flow diagram depicting certain aspects of example control processes which may be utilized in controlling one or more vehicles of a vehicle platoon.

FIG. 4 is a flow diagram depicting certain aspects of example control processes which may be utilized in controlling one or more vehicles of a vehicle platoon.

FIG. 5 is a schematic diagram depicting certain aspects of an example electronic controls which may be utilized in controlling one or more vehicles of a vehicle platoon.

FIG. 6 is a schematic diagram depicting certain aspects of an example electronic controls which may be utilized in controlling one or more vehicles of a vehicle platoon.

FIG. 7 is a schematic diagram depicting certain aspects of an example electronic controls which may be utilized in controlling one or more vehicles of a vehicle platoon.

### DETAILED DESCRIPTION OF ILLUSTRATIVE EMBODIMENTS

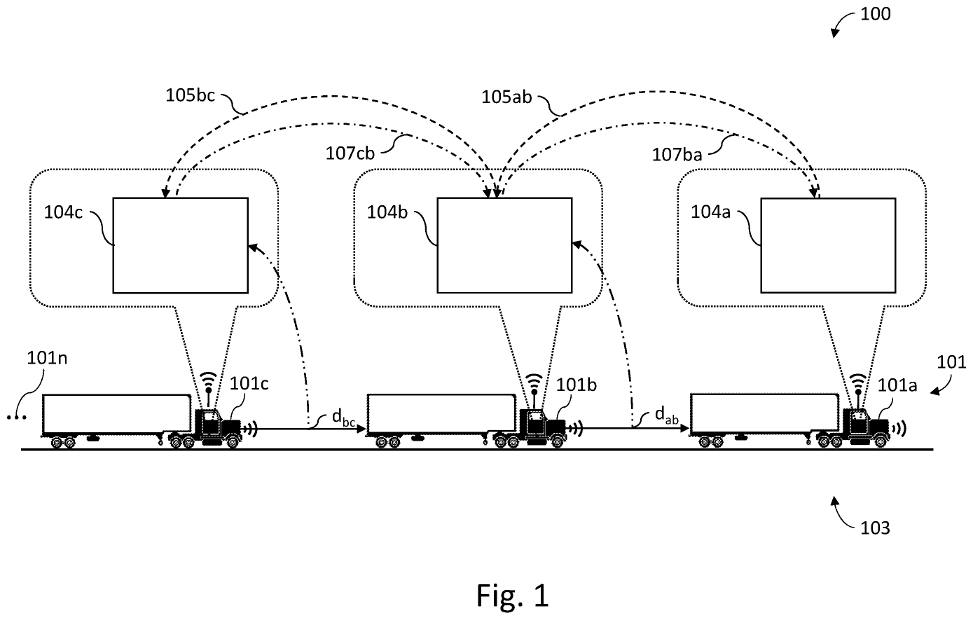

With reference to FIG. 1, there is illustrated a schematic view of an example vehicle platoon 103 is illustrated in a platooning mode of operation in which the operation of vehicles 101 is controlled in a coordinated manner according to one or more of the apparatuses, methods, systems, and techniques disclosed herein. It shall be appreciated that the disclosed apparatuses, methods, systems, and techniques may be configured and operable to reduce net fuel consumption and increase net operating efficiency of the vehicle platoon 103. It shall be appreciated that the disclosed apparatuses, methods, systems, and techniques may be configured and operable to mitigate degradation or interruption of platooning operation as may occur, for example, when an inter-vehicle distance of the vehicle platoon increases. An increase in inter-vehicle distance of the vehicle platoon increases may degrade or negate aerodynamic advantages, allow interruption of platooning, for example, by permitting uninvited vehicle entry into a gap between platoon vehicles, or both.

In the illustrated example, vehicle platoon 103 is illustrated as including a plurality of vehicles 101a, 101b, 101c, and potentially additional vehicles 101n as indicated by an ellipsis. Vehicles 101a, 101b, 101c, and other vehicles 101n may be referred to individually as a vehicle 101 and collectively as vehicles 101 or collectively as vehicle platoon 103. It shall nevertheless be appreciated vehicle platoons according to the present disclosure may comprise any number of two or more vehicles traveling in proximity to one another such that information about characteristics, operation and/or performance of one or more of the vehicles can be obtained and processed to adjust or tune the power or performance characteristics of one or more of the vehicles in the platoon.

Each of vehicles 101 may be any of a variety of types of vehicles such as trucks, tractor-trailers, box trucks, buses, and passenger cars, among others. In the illustrated example, vehicles 101 are depicted as tractor-trailers, but other types of vehicles, such as the foregoing, are contemplated herein. Vehicles 101 may each be the same or similar types of vehicles, for example, in the case of a commonly managed vehicle fleet, or may be a heterogeneous group or set of vehicles which may comprise different types or classes of vehicles, for example, semi tractor-trailers and passenger cars. Regardless of the similarity of or differences between vehicles 101, the cargo load of vehicles 101 may vary among vehicles 101 at a given time and for each of vehicles 101 and among vehicles 101 over time.

Each vehicle 101 includes a prime mover (not visible in the illustrated view), such as an internal combustion engine, hybrid engine-electric system, or fuel cell-electric system, structured to output power to propel the vehicle 101. Some embodiments contemplate that prime movers may each be the same or similar types of prime movers, for example, in the case of a commonly managed vehicle fleet. Some embodiments contemplate that prime movers may comprise different types or classes of prime movers, for example, prime movers of different sizes, powers or types (e.g., diesel engine powertrains, gasoline engine powertrains, natural gas powertrains, hydrogen combustion powertrains, hybrid-electric powertrains, and electric powertrains). For convenience of description prime mover may be referred to herein as an engine, however, it shall be understood that references to an engine are not limited to an internal combustion engine and instead also apply to and include other types of prime movers such as the foregoing and other examples disclosed herein.

Each vehicle 101 utilizes one or more environmental sensors (not depicted in the view of FIG. 1) to determine its positioning relative to other vehicles in vehicle platoon 103. Examples of the types of sensor systems that may be utilized include RADAR systems, LIDAR systems, proximity sensor systems, camera systems, and combinations of these and/or other sensor systems. Each vehicle 101 in vehicle platoon 103 also includes a wireless communication system allowing vehicle-to-vehicle (V2V) communication or vehicle-to-X (V2X) communication where X denotes a variety of possible types of external networks including, for example, networks associated with stationary infrastructure assets.

Each vehicle 101 includes an electronic control system (ECS) (e.g., ECS 104a of vehicle 101a, ECS 104b of vehicle 101b, and ECS 104c of vehicle 101c) which is structured to control and monitor operation of its respective vehicle 101, as well as to participate in one or more of the coordinated operation as disclosed herein. An example ECS comprises one or more integrated circuit-based electronic control units (ECU) or other control components which may be operatively coupled to one another over a communication bus or network such as a controller area network (CAN) and which are structure to implement various controls, for example, an engine ECU structured to control and monitor operation of an engine and engine accessories, a transmission ECU structured to control and monitor operation of a transmission, a wireless communication ECU structured to control ex-vehicle wireless communications, and one or more environmental sensor ECUs structured to control operation of an environmental sensor system may be provided. It shall be appreciated that the control logic and control processes disclosed herein may be performed by controllers or controls which are implemented in dedicated control components of the ECS (e.g., in a dedicated ECU or other dedicated control circuitry) or may be implemented in a distributed fashion across multiple control components of ECS (e.g., through coordinated operation of an engine ECU, a transmission ECU, a wireless communication ECU and an environmental sensor ECU).

The ECUs and other control components of the ECS may comprise digital circuitry, analog circuitry, or hybrid combinations of both of these types. The ECUs and other control components of the ECS can be programmable, an integrated state machine, or a hybrid combination thereof. The ECUs and other control components of the ECS can include one or more Arithmetic Logic Units (ALUs), Central Processing Units (CPUs), memories, limiters, conditioners, filters, format converters, or the like which are not shown to preserve clarity. In one form, the ECS is of a programmable variety that executes algorithms and processes data in accordance with operating logic that is defined by executable program instructions stored in a non-transitory memory medium (e.g., software or firmware). Alternatively or additionally, operating logic for the ECS can be at least partially defined by hardwired logic or other hardware.

It shall be appreciated that electronic control systems and components thereof disclosed herein may be configured to determine or obtain a parameter, quantity, value or other operand based upon another parameter, quantity, value or other operand in a number of manners including, for example, by calculation, computation, estimation or approximation, look-up table operation, receiving a parameter, quantity, value or other operand from one or more other components or systems and storing such received parameter, quantity, value or other operand in a non-transitory memory medium associated with the electronic control systems or components thereof, other determination techniques or techniques of obtaining as would occur to one of skill in the art with the benefit of the present disclosure, or combinations thereof. Likewise the disclosed acts of determination or determining or obtaining a parameter, quantity, value or other operand based upon another parameter, quantity, value or other operand may comprise a number acts including, for example, acts of calculation, computation, estimation or approximation, look-up table operation, receiving a parameter, quantity, value or other operand from one or more other components or systems and storing such received parameter, quantity, value or other operand in a non-transitory memory medium associated with the electronic control systems or components thereof, other determination techniques or techniques of obtaining as would occur to one of skill in the art with the benefit of the present disclosure, or combinations thereof.

The environmental sensor and wireless communication capabilities of vehicles 101 allow their operation to be coordinated using direct or indirect communication. For example, vehicles 101 may accelerate or brake simultaneously, or in a coordinated sequence, maintain a particular distance relative to one another, or maintain a particular offset relative to one another. Coordinated operation also allows a closer following distance between vehicles by compensating for or eliminating distance needed for human reaction. Coordinate operation of vehicle platoon 103 further allows for operation that reduces net fuel consumption or increases net efficiency of the vehicle platoon 103. One or more of the vehicles 101 may in some embodiments, be equipped with aerodynamic capability (wind assist panels on cab & trailer, aerodynamic tractor body) that creates a laminar flow of air (tunnel effect) that greatly reduces air drag. Other vehicles among vehicles 101 may be spaced close enough to the vehicle taking advantage of a wind break tunnel to increase fuel economy. It shall be appreciated that the controls disclosed herein can mitigate aerodynamic losses both by adjusting vehicle following distance(s) and vehicle offset.

The respective ECS of each of vehicles 100 is configured and operable to send and received inter-vehicle transmissions in a bi-directional manner. In the illustrated example, ECS 104a of vehicle 101a sends a transmission 105ab which is received by ECS 104b of vehicle 101b, and ECS 104b of vehicle 101b sends a transmission 107ba which is received by ECS 104a of vehicle 101a. Likewise, ECS 104b of vehicle 101a sends a transmission 105bc which is received by ECS 104c of vehicle 101c, and ECS 104c of vehicle 101c sends a transmission 107cb which is received by ECS 104b of vehicle 101b. Similar bi-directional communication may occur relative to one or more other vehicles 101n of platoon 103. In the illustrated example, each of vehicles 101 is in bi-directional communication with its respective immediately forward vehicle (if present, e.g., in the case of a non-lead vehicle) and its respective immediately rearward vehicle (if present, e.g., in the case of a non-caboose vehicle). It is also contemplated that one or more of vehicles 101 may be in bi-directional communication with other forward vehicles (if present) and other rearward vehicles (if present).

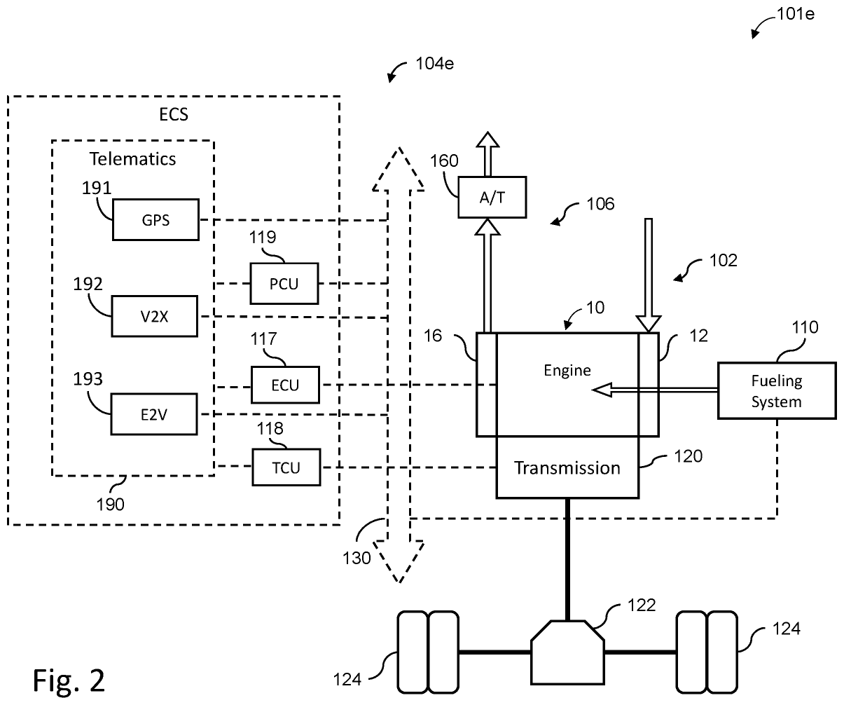

With reference to FIG. 2, there is illustrated an example vehicle system 101e (also referred to herein as system 101e) according to one example embodiment. System 102e is one example of a vehicle configuration that may be provided in any one or more of vehicles, 101a, 101b, 101c, 101n of vehicle platoon 103. Furthermore, system 102e includes an ECS 104e which is one example of an electronic control system configuration that may be provided in any one or more of vehicles, 101a, 101b, 101c, 101n of vehicle platoon 103. It shall be appreciated that in other embodiments, and forms, system 101e and ECS 104e may include additional or alternative features including, for example, the alternatives, options, and variations disclosed elsewhere herein.

System 101e includes an engine 10 having an intake manifold 12 and an exhaust manifold 16. System 101e includes an intake system 102 fluidly coupled to the intake manifold 12 and an exhaust system 106 fluidly coupled to the exhaust manifold 16. The intake system 102 may be configured as a turbocharged system configured to provide compressed intake charge air to intake manifold 12 from an exhaust-driven turbocharger. In other embodiments, the turbocharger may alternatively be configured as a shaft-driven compressor or supercharger or may be omitted in the case of a naturally aspirated engine. System 101e may also include an exhaust gas recirculation (EGR) system, an intake throttle, an exhaust throttle, and various other intake system components as will occur to one of skill in the art with the benefit and insight of the present disclosure.

The exhaust system 106 may include one or more exhaust aftertreatment components 160 for mitigation of emissions including, for example, hydrocarbons, particulate matter, and oxides of Nitrogen (NOx). The one or more exhaust aftertreatment components 160 may include, for example, oxidation catalysts, particular filters, selective catalytic reduction (SCR) catalysts and associated SCR system components, and various other exhaust aftertreatment system components as will occur to one of skill in the art with the benefit and insight of the present disclosure.

System 101e includes a fueling system 110 operationally coupled to the engine 10. Fueling system 110 may be provided in a number of forms, for example, a natural gas system or other gaseous fuel systems, a gasoline system, or a dual-fuel system. When provided as a dual fuel system, fueling system 110 may be configured to provide multiple fuels to the combustion chamber, for example, gaseous fuel and liquid fuel. In such systems, combustion may be controlled by injection of the liquid fuel to the combustion cylinder to ignite the gaseous fuel. Fueling system 110 may utilize port fuel injection and/or direct injection.

System 101e includes a transmission 120 which may be provided in a number of forms and configurations including, for example, automatic transmissions, automated-manual transmissions (AMT), or other types of transmissions. Transmission 120 receives torque output by engine 10 and provides output torque to differential 122. In turn, differential 122 outputs torque to drive wheels 124.

System 101e includes telematics system 190. In the illustrated example, telematics system 190 includes a global positioning system (GPS) receiver 191, a vehicle-to-everything (V2X) receiver 192, and one or more environment-to-vehicle (E2V) receivers 193. Other embodiments may include telematics systems that include only one of GPS receiver 191 and V2X receiver 192, or that include additional or alternative telematics devices and systems. GPS receiver 191 may be configured to receive satellite-based and/or terrestrial-based GPS signals. V2X receiver 192 may be configured to receive signals from terrestrial infrastructure, other vehicles, or other sources. V2X receiver 192 may be configured as a transceiver configured for two-way communication or may be paired with a separate V2X transmitter. The one or more environment-to-vehicle (E2V) receivers 193 may include, for example, RADAR devices or systems, LIDAR devices or systems, proximity sensor devices or systems, or camera and image processing devices or systems, or combinations thereof.

System 101e includes an electronic control system (ECS) 104e which includes control circuitry configured to control a number of operational aspects of system 101e. The control circuitry of ECS 104e may be provided in a number of forms and combinations. In some embodiments, the control circuitry of ECS 104e may be provided in whole or in part by one or more microprocessors, microcontrollers, other integrated circuits, or combinations thereof which are configured to execute instructions stored in a non-transitory memory medium, for example, in the form of stored firmware and/or stored software. It shall be appreciated microprocessor, microcontroller and other integrated circuit implementations of the control circuitry disclosed herein may comprise multiple instances of control circuitry which utilize common physical circuit elements. For example, first control circuitry may be provided by a combination of certain processor circuitry and first memory circuitry, and second control circuitry may be provided by a combination of, at least in part, that certain processor circuitry and second memory circuitry differing from the first memory circuitry.

It shall be further appreciated that the control circuitry of ECS 104e may additionally or alternatively comprise other digital circuitry, analog circuitry, hybrid analog-digital circuitry, or combinations thereof. Some non-limiting example elements of such circuitry include application specific integrated circuits (ASICs), arithmetic logic units (ALUs), amplifiers, analog calculating machine(s), analog to digital (A/D) and digital to analog (D/A) converters, clocks, communication ports, field programmable gate arrays (FPGAs), filters, format converters, modulators or demodulators, multiplexers, and de-multiplexers, non-transitory memory devices and media, oscillators, processors, processor cores, signal conditioners, state machine(s), and timers. As with microprocessor, microcontroller, and other integrated circuit implementations, such alternate or additional implementations may implement or utilize multiple instances of control circuitry which utilize common physical circuit elements. For example, first control circuitry may be provided by a combination of first control circuitry elements and second control circuitry elements, and second control circuitry may be provided by a combination of the first control circuitry elements and third control circuitry elements differing from the first control circuitry elements.

ECS 104e may be provided as a single component or physical unit or a collection of operatively coupled components or physical units. When of a multi-component or multi-unit form, ECS 104e may have one or more components remotely located relative to the others in a distributed arrangement and may distribute the control function across one or more control units or devices. In the illustrated example, ECS 104e includes multiple electronic control units including engine control unit (ECU) 117, transmission control unit (TCU) 118, and platooning control unit (PCU 119). In general, ECU 117, TCU 118, and PCU 119 are configured to respectively control engine 10, transmission 120, and telematics system 190, ECU 117, TCU 118, and PCU 119 are also configured to operatively communicate with one another either directly or via one or more networks 130 such as one or more controller area networks (CANs) and may also be configured to communicate with various systems, devices, and sensors of system 101e via dedicated communication links of via one or more CANs. Example communication connections are illustrated in FIG. 2, although in any given embodiment connections illustrated may not be present, and/or additional connections may be present.

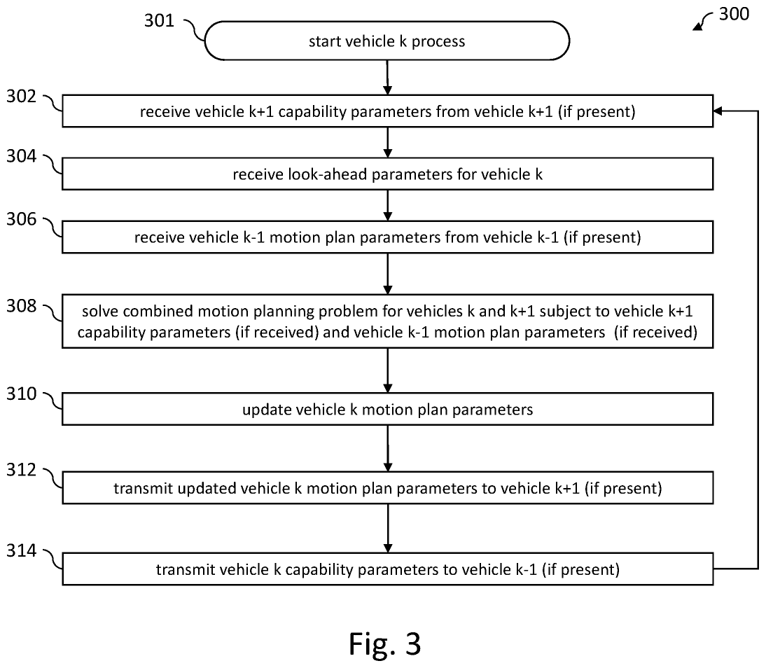

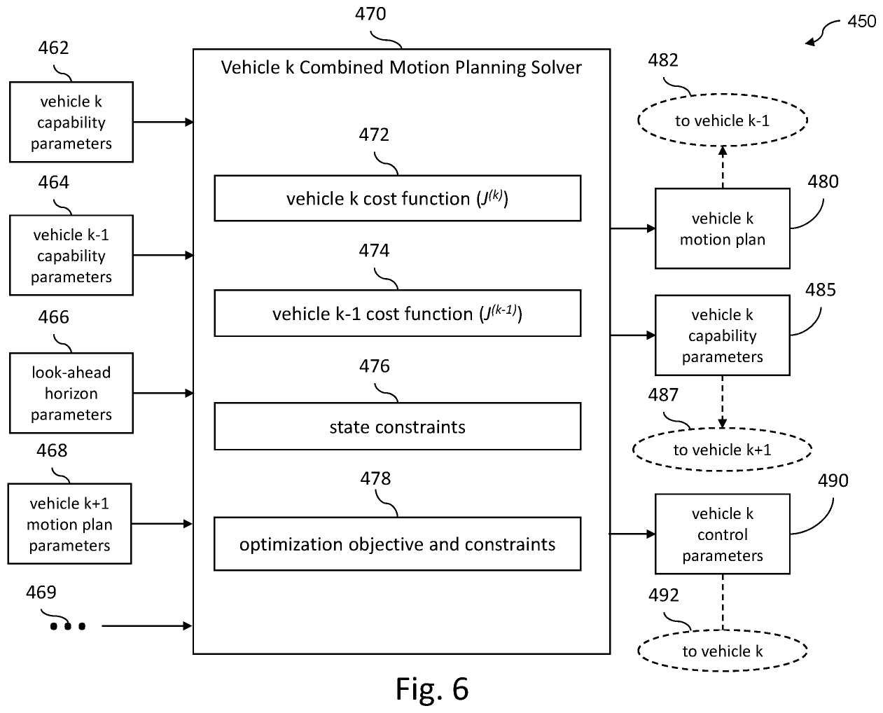

With reference to FIGS. 3, 4, 5, 6, and 7 there are illustrated an example process 300, an example process 350, example controls 400, example controls 450, and example system 700, which are examples of considerate motion planning methods and systems according to the present disclosure which may be configured and operated to proposed to compensate and assist less-capable vehicles. In some embodiments, the goals of such methods, controls, and systems may be to maintain platoonable gaps during highway operation, improve velocity synchronization between platooned vehicles, improve independence of automated vehicles to reduce driver intervention, and improve fuel economy of the total platoon. Such methods, controls, and systems may rely on a bi-directional communication topology as illustrated in FIG. 1, in which a vehicle k receives necessary control parameters from its immediate neighbor following vehicle k+1, solves a distributed motion planning problem for itself that considers the vehicle behind it, in which it takes actions to: regulate their combined control efforts, help vehicle k+1 maintain its desired gap, and, if it is the leader of the platoon, track a target desired velocity. Solving the combined motion planning problem aids in predicting the response the ego can take that benefits both vehicles. Vehicle k then broadcasts its planned forward positions (Sr) and suggested control actions (Ur) for vehicle k+1 to follow as a reference for its own motion planning, which serve as a soft level of compliance so that each following vehicle is behaving as expected by others in the platoon.

With reference to FIG. 3, there is illustrated example control process 300. Process 300 may be implemented or provided in one or more components of an electronic control system of a vehicle, such as ECS 104e of system 101e which, as noted above, provides one example of an ECS that may be implemented in one or more vehicles of a vehicle platoon such as vehicle 101a, 101b, 101c, 101n of vehicle platoon 103 or other vehicles of other vehicle platoons.

Process 300 may be implemented or provided in one of more electronic control system components of any or every vehicle of a platoon, although certain operations may be executed or performed for and a vehicle k is a forward vehicle and has at least one following vehicle (referred to in the present example as vehicle k), and certain other operations may be executed or performed for and a vehicle k is a following vehicle and has at least one forward vehicle (referred to in the present example as vehicle k−1). Thus, in the case of a vehicle k that is a lead vehicle (e.g., the first or forward-most vehicle in a platoon), process 300 may omit certain operations, and in the case of a vehicle k that is a caboose vehicle (e.g., the last or rearward-most vehicle in a platoon), process 300 may omit certain other operations.

Process 300 begins at operation 301 which starts a vehicle k process, for example, in response to telematics inputs indicating that a vehicle is in or entering into platooning operation with a position or status as a vehicle k. From operation 301, process 300 proceeds to operation 302.

Operation 302 receives vehicle k+1 capability parameters if a following vehicle k+1 is present in the platoon including vehicle k. The vehicle k+1 capability parameters may be received, for example, by or via one or more components or elements of a telematics system, such as telematics system 190, such as a vehicle-to-X (V2X) communication system which receives a wireless transmission initiated or sent from vehicle k+1. The vehicle k+1 capability parameters may include any of the vehicle capability parameters disclosed herein.

The vehicle k+1 capability parameters may be determined in response to the vehicle k motion plan parameters and the look ahead parameters for vehicle k+1. For example, the vehicle k+1 capability parameters may be determined based on predetermined or dynamically determined information and may include mass, powertrain capability, vehicle model information, powertrain model information. The vehicle k+1 capability parameters may include a current gear of vehicle k+1 (î^{(k+1)}), a current gap, velocity, and traction for vehicle k+1 (x^{(k+1)}), a mass of vehicle k+1 (m^{(k+1)}), and engine power and torque limitations for vehicle k+1 (P̅^{(k+1)}) and/or any of the vehicle k+1 parameters disclosed herein. From operation 302, process 300 proceeds to operation 304.

Operation 304 receives look ahead parameters for vehicle k. The look ahead parameters for vehicle k may be received, for example, by or via one or more components or elements of a telematics system, such as telematics system 190, such as a vehicle-to-X (V2X) communication system and/or a GPS system which receive respective wireless transmission initiated or sent from a satellite or terrestrial (fixed or mobile) transmission source. The look ahead parameters may include any of the look-ahead parameters disclosed herein. From operation 304, process 300 proceeds to operation 306.

Operation 306 receives vehicle k−1 motion plan parameters if a forward vehicle k−1 is present in the platoon including vehicle k. The vehicle k−1 motion plan parameters may be received, for example, by or via one or more components or elements of a telematics system, such as telematics system 190, such as a vehicle-to-X (V2X) communication system which receives a wireless transmission initiated or sent from vehicle k+1. The vehicle k−1 motion plan parameters may include any of the vehicle motion plan parameters disclosed herein. From operation 306, process 300 proceeds to operation 308.

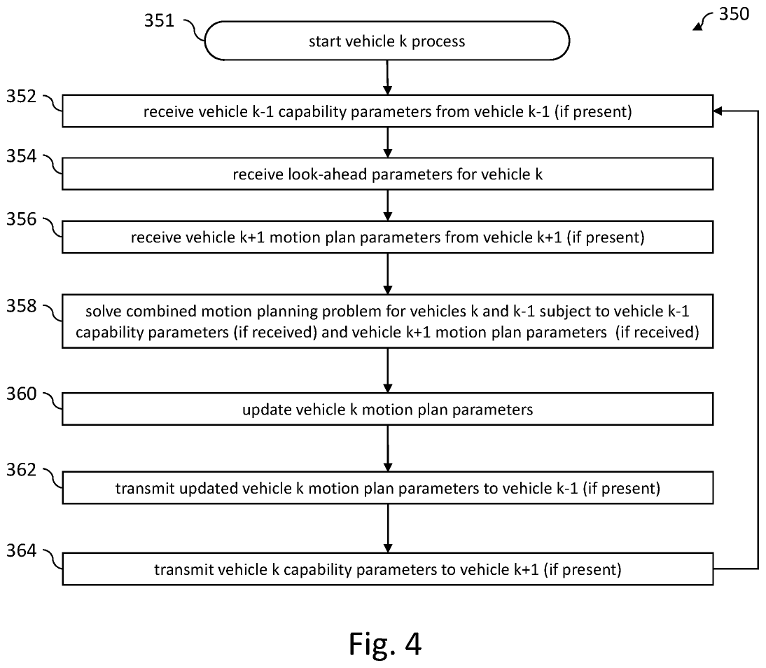

Operation 308 solves a combined motion planning problem for vehicle k and vehicle k+1 subject to vehicle k+1 capability parameters (if received, e.g., if a vehicle k+1 is present and communicating as expected) and vehicle k−1 motion plan parameters (if received, e.g., if a vehicle k−1 is present and communicating as expected). In formulating and solving such a combined motion planning problem, operation 306 may utilize components, operations, and techniques such as those disclosed below in connection with FIG. 4. From operation 308, process 300 proceeds operation 310.

Operation 310 updates vehicle k motion plan parameters. The update performed by operation 310 may include updating one or more future vehicle k positions, velocities, accelerations, or a combination thereof. The update performed by operation 310 may include multiple instances or sets of such future vehicle k positions, velocities, accelerations, or combinations, for example, over a look ahead horizon at a plurality of positions, a plurality of times, or a plurality of position-times (e.g., position and time pairs). The update performed by operation 308 may include other future parameters which may also be provide in multiple instances or sets. From operation 310, process 300 proceeds to operation 312.

Operation 312 transmits vehicle k motion plan parameters to vehicle k+1 if a following vehicle k+1 is present in the platoon including vehicle k. The transmission may be sent, for example, by or via one or more components or elements of a telematics system, such as telematics system 190, such as a vehicle-to-X (V2X) communication system which provides a wireless transmission initiated or sent from vehicle k. The transmission may comprise one or more planned future vehicle positions for vehicle k (Sᵣ). The transmission may additionally or alternatively comprise one or more suggested control actions for vehicle k+1 (Uᵣ). From operation 312, process 300 proceeds to operation 314.

Operation 314 transmits vehicle k capability parameters to vehicle k−1 if a forward vehicle k−1 is present in the platoon including vehicle k. The transmission may be sent, for example, by or via one or more components or elements of a telematics system, such as telematics system 190, such as a vehicle-to-X (V2X) communication system which provides a wireless transmission initiated or sent from vehicle k. The transmission may comprise any of the vehicle capability parameters disclosed herein. From operation 314, process 300 proceeds to operation 302 and from there proceeds as described above.

With reference to FIG. 4, there is illustrated example control process 350. Process 350 may be implemented or provided in one or more components of an electronic control system of a vehicle, such as ECS 104e of system 101e which, as noted above, provides one example of an ECS that may be implemented in one or more vehicles of a vehicle platoon such as vehicle 101a, 101b, 101c, 101n of vehicle platoon 103 or other vehicles of other vehicle platoons. It shall be appreciated that controls 400 constitute structure in terms of one or both of physical components and the configuration of physical components, such as instructions stored in non-transitory memory media.

Process 350 may be implemented or provided in one of more electronic control system components of any or every vehicle of a platoon, although certain operations may be executed or performed for and a vehicle k is a forward vehicle and has at least one following vehicle (referred to in the present example as vehicle k), and certain other operations may be executed or performed for and a vehicle k is a following vehicle and has at least one forward vehicle (referred to in the present example as vehicle k−1). Thus, in the case of a vehicle k that is a lead vehicle (e.g., the first or forward-most vehicle in a platoon), process 350 may omit certain operations, and in the case of a vehicle k that is a caboose vehicle (e.g., the last or rearward-most vehicle in a platoon), process 350 may omit certain other operations.

Process 350 begins at operation 351 which starts a vehicle k process, for example, in response to telematics inputs indicating that a vehicle is in or entering into platooning operation with a position or status as a vehicle k. From operation 351, process 350 proceeds to operation 352.

Operation 352 receives vehicle k−1 capability parameters if a forward vehicle k−1 is present in the platoon including vehicle k. The vehicle k−1 capability parameters may be received, for example, by or via one or more components or elements of a telematics system, such as telematics system 190, such as a vehicle-to-X (V2X) communication system which receives a wireless transmission initiated or sent from vehicle k+1. The vehicle k−1 capability parameters may include any of the vehicle capability parameters disclosed herein. From operation 352, process 350 proceeds to operation 354.

Operation 354 receives look ahead parameters for vehicle k. The look ahead parameters for vehicle k may be received, for example, by or via one or more components or elements of a telematics system, such as telematics system 190, such as a vehicle-to-X (V2X) communication system and/or a GPS system which receive respective wireless transmission initiated or sent from a satellite or terrestrial (fixed or mobile) transmission source. The look ahead parameters may include any of the look-ahead parameters disclosed herein. From operation 354, process 350 proceeds to operation 356.

Operation 356 receives vehicle k+1 motion plan parameters if a following vehicle k+1 is present in the platoon including vehicle k. The vehicle k+1 motion plan parameters may be received, for example, by or via one or more components or elements of a telematics system, such as telematics system 190, such as a vehicle-to-X (V2X) communication system which receives a wireless transmission initiated or sent from vehicle k+1. The vehicle k+1 motion plan parameters may include any of the vehicle motion plan parameters disclosed herein. From operation 356, process 350 proceeds to operation 358.

Operation 358 solves a combined motion planning problem for vehicle k and vehicle k−1 subject to vehicle k−1 capability parameters (if received, e.g., if a vehicle k−1 is present and communicating as expected) and vehicle k+1 motion plan parameters (if received, e.g., if a vehicle k+1 is present and communicating as expected). In formulating and solving such a combined motion planning problem, operation 356 may utilize components, operations, and techniques such as those disclosed below in connection with FIG. 4. From operation 358, process 350 proceeds operation 360.

Operation 360 updates vehicle k motion plan parameters. The update performed by operation 360 may include updating one or more future vehicle k positions, velocities, accelerations, or a combination thereof. The update performed by operation 360 may include multiple instances or sets of such future vehicle k positions, velocities, accelerations, or combinations, for example, over a look ahead horizon at a plurality of positions, a plurality of times, or a plurality of position-times (e.g., position and time pairs). The update performed by operation 358 may include other future parameters which may also be provide in multiple instances or sets. From operation 360, process 350 proceeds to operation 362.

Operation 362 transmits vehicle k motion plan parameters to vehicle k−1 if a forward vehicle k−1 is present in the platoon including vehicle k. The transmission may be sent, for example, by or via one or more components or elements of a telematics system, such as telematics system 190, such as a vehicle-to-X (V2X) communication system which provides a wireless transmission initiated or sent from vehicle k. The transmission may comprise one or more planned future vehicle positions for vehicle k (Sᵣ). The transmission may additionally or alternatively comprise one or more suggested control actions for vehicle k−1 (Uᵣ). From operation 362, process 350 proceeds to operation 364.

Operation 364 transmits vehicle k capability parameters to vehicle k+1 if a following vehicle k+1 is present in the platoon including vehicle k. The transmission may be sent, for example, by or via one or more components or elements of a telematics system, such as telematics system 190, such as a vehicle-to-X (V2X) communication system which provides a wireless transmission initiated or sent from vehicle k. The transmission may comprise any of the vehicle capability parameters disclosed herein. From operation 364, process 350 proceeds to operation 352 and from there proceeds as described above.

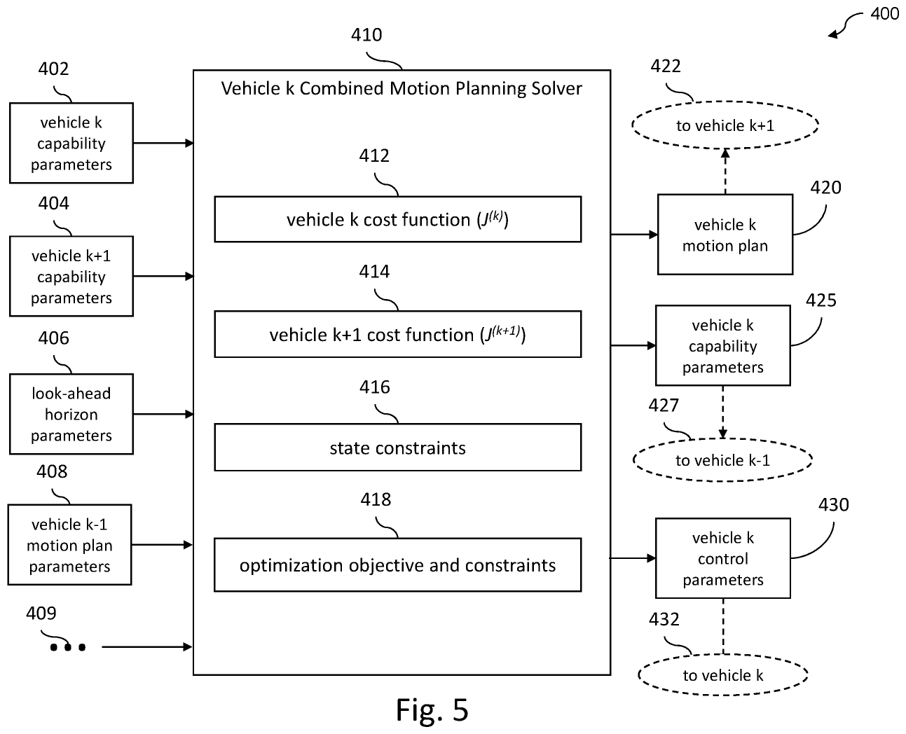

With reference to FIG. 5, there are illustrated example controls 400 which may be implemented or provided in one or more components of an electronic control system (ECS) of a vehicle, such as any or all of the ECS described in connection with FIGS. 1 and 2 or another ECS of a vehicle. It shall be appreciated that controls 400 are structural in nature in that they describe one or both of physical components and the configuration of physical components, such as code, data structures, executables, or instructions stored in non-transitory memory media.

Controls 400 include a combined motion planning solver 410 (also referred to herein as solver 410) which may be configured according to any of a number of model predictive controller (MPC) implementations and topologies as will occur to one of skill in the art with the benefit and insight of the present disclosure including, for example, linear, piecewise linear, non-linear, hybrid, adaptive, stochastic, machine learning-based MPC implementations and topologies. Solver 410 is configured to solve a combined motion planning problem for vehicle k and vehicle k+1 subject to vehicle k+1 capability parameters (if present, e.g., if a vehicle k+1 is present and communicating as expected) and vehicle k+1 motion plan parameters (if present, e.g., if a vehicle k+1 is present and communicating as expected).

Solver 410 may be configured to receive a plurality of inputs. In the illustrated example, solver 410 is configured to receive vehicle k capability parameters 402, vehicle k+1 capability parameters 404, look-ahead horizon parameters 406, and vehicle k−1 motion plan parameters 408, and may further be configured to receive a number of other parameters 409 as denoted by an ellipsis. Vehicle k capability parameters 402 may include, for example, current gear, velocity, distance from forward vehicle (if present), traction, mass, and engine power and torque limitations of vehicle k, as well as a number of other parameters pertaining to the capability of vehicle k. Vehicle k+1 capability parameters 404 may include, for example, current gear, velocity, distance from forward vehicle, traction, mass, and engine power and torque limitations of vehicle k, as well as a number of other parameters pertaining to the capability of vehicle k+1. Look-ahead horizon parameters 406 may include, for example, future or upcoming road grade, road direction or curvature, altitude, wind speed and direction, precipitation information, traffic flow information, and speed limit information, as well as a number of other a parameters as will occur to one of skill in the art with the benefit and insight of the present disclosure.

Vehicle k−1 motion plan parameters 408 may include, for example, recommended control or operation parameters for vehicle k, for example, acceleration, position, velocity, and/or other control or operation parameters. Such parameters may be configured in terms of objectives or results to be achieved (e.g., acceleration, position, velocity, and/or other conditions of vehicle k). Such parameters may also be configured in terms of commands or settings for particular components or systems of vehicle k (e.g., braking, powertrain, power, torque, or output, and/or other commands or settings).

In the illustrated example, solver 410 includes or utilizes a vehicle k cost function 412 which is a cost function established for a given vehicle k (e.g., the vehicle on or in connection with which controls 400 are implemented), and a vehicle k+1 cost function 414 which is a cost function established for a vehicle following vehicle k (e.g., the vehicle immediately following vehicle k). In other embodiments, solver 410 may include cost functions for other vehicles, or may vary the designation of a particular vehicle assigned to vehicle k+1 according to a formation or order of a current or anticipated vehicle platoon.

One or both of vehicle k cost function 412 and vehicle k+1 cost function 414 may be configured to account for a number of parameters relevant to vehicle motion planning. In one example embodiment, vehicle k cost function 412 and vehicle k+1 cost function 414 may be configured according to equation (1) below.

$${J}^{( k )} = {{q}_{t} ( \frac{{s}_{f} - {s}_{N}^{k}}{{t}_{f} - {t}_{N}} - {v}_{N}^{( k )} )}^{2} + {\sum }_{i = 0}^{i = N - 1} [ {{q}_{u} ( {u}_{i}^{k} )}^{2} + {{q}_{v} ( {( {v}_{i} - v )}^{k \vert k = 1} )}^{2} + {{q}_{d} ( {( {d}_{i} - {Tv}_{i} )}^{k \vert k > 1} )}^{2} + {{q}_{c} ( {( {u}_{i} - {μ}_{i} )}^{k \vert k > 1} )}^{2} ] + + {q}_{ϵ} {ϵ}^{( k )} \qquad ( 1 )$$

where
J^{(k)} is the cost function for vehicle k,
k denotes a given vehicle,
k+1 denotes a vehicle following vehicle k,
k|k=1 denotes an operation performed if vehicle k is a lead vehicle,
k|k>1 denotes an operation performed if vehicle k is a vehicle following the lead vehicle,
i denotes the stage of the motion planning problem,
N denotes the number of stages of the motion planning problem,
qₜ, qᵤ, q_{ν}, q_{d}, q_{c}, and q_{ε} are weighting coefficients for various terms of the performance metric defined by J^{(k)},
s_{f} is a final destination position of a defined mission,
s_{N}^{(k)} is the position of vehicle k for the end of a given prediction horizon N,
t_{f} is the desired trip time to the final destination,
t_{N} is the time at the end of a given prediction horizon N,
collectively,

$$\frac{sf - {s}_{N}^{( k )}}{tf - tN}$$

refers to a terminal sped that tracks an average velocity needed to reach the remaining distance-to-go in the trip (sf−s_{N}^{(k)}) in the remaining desired time to go (tf−tN) at the end of a look ahead horizon,
v_{N}^{(k)} is speed of vehicle k at the end of a given prediction horizon N,
uᵢ^{(k)} is the stage dependent tractive acceleration command (or any control action) for vehicle k,
dᵢ is iteration dependent inter-vehicle distance,
T is a desired inter-vehicle following distance as a function of speed (also referred to as headway time),
vᵢ is the speed of vehicle k at a given iteration i over a prediction horizon,
ν is an in-horizon velocity reference indicating the desired speed target for vehicle k,
μᵢ is the stage dependent control action suggested from a preceding vehicle,
ε^{(k)} is a slack decision variable associated with vehicle k used to soften the inter-vehicle distance constraint.

In the illustrated example, solver 410 includes or utilizes state constraints 416 which may be selected based on safety and speed limit or other regulatory or legal considerations. State constraints 416 may, for example, constrain the velocity of vehicle k (v^{(k)}) with a velocity limit (0≤v^{(k)}≤vₗᵢₘ^{(k)}) in accordance with equation (2) and minimum safe distance for vehicle k (dₘᵢₙ) which is less than an inter-vehicle distance (dᵢ^{(k)}) and a distance dependent on vehicle velocity of lead vehicle of a platoon (vᵢ^{(k|k=1)}), and a slack decision variable associated with vehicle k used to soften the inter-vehicle distance constraint (ε^{(k)}) in accordance with equation (3).

0≤v^{(k)}≤vₗᵢₘ^{(k)} (2)

dₘᵢₙ≤dᵢ^{(k)}+Tvᵢ^{(k|k=1)}+ε^{(k)} (3)

In the illustrated example, solver 410 includes optimization objectives and constraints 418 which defines an optimization objective and constraints on the optimization objective for which solver 410 determines a solution. Solver 410 may be configured to solve a joint optimization problem for vehicle k and vehicle k+1 which may be defined at least in part by optimization objectives and constraints 418. In performing such joint optimization, solver 410 may be configured to account for performance capability parameters of vehicle k and vehicle k+1. In one embodiment, optimization objectives and constraints 418 defines its optimization objective in accordance with equation (4) and defines its constraints in accordance with equations (5).

minimize: J^{(k)}+J^{(k+1)} in U^{(k)},+U^{(k+1)} (4)

subject to: \dot{x}^{(k)}−ƒ(x^{(k)},u^{(k)},w^{(k)})

\dot{x}^{(k+1)}=ƒ(x^{(k)},x^{(k+1)},u^{(k+1)},w^{(k+1)})

u^{(k)}∈U^{(k)},x^{(k)}∈X^{(k)}

u^{(k+1)}∈U^{(k+1)},x^{(k+1)}∈X^{(k+1)} (5)
where: J^{(k)}is a cost function for vehicle k,
   J^{(k+1)} is a cost function for vehicle k+1,
   U^{(k)} is an admissible control set for vehicle k,
   \dot{x}^{(k)}=ƒ(x^{(k)}, u^{(k)}, w^{(k)}) is a state space model for vehicle k in which a state space (\dot{x}^{(k)}) is a function of a state vector (x^{(k)}), tractive acceleration command for vehicle k (u^{(k)}), and weight (or mass) factor (w^{(k)},
   U^{(k+1)} is an admissible control set for vehicle k+1,
   \dot{x}^{(k+1)}=ƒ(x^{(k)} x^{(k+1)}u^{(k+1)}, w^{(k+1)}) is a state space model for vehicle k in which a state space (\dot{x}^{(k)}) is a function of the state vector (x^{(k)}) and a corresponding state vector for vehicle k+1 (x^{(k+1)}), a tractive acceleration command for vehicle k+(u^{(k+1)}), and a weight (or mass) factor for vehicle k+1 (w^{(k+1)}), and
   the symbol ∈ denotes that a preceding term belongs to a set given by the following term.

Optimization objectives and constraints 418 may define or model the parameters of equations (4) and (5) in a number of manners. For example, the admissible control set for vehicle k (U^{(k)}) and the admissible control set for vehicle k+1 (U^{(k+1)}) may be defined based on the maximum engine torque accounting for losses and gearing effects intermediate the engine and the wheels and further based on the maximum engine power. Furthermore, the state vector may be further defined as x^{(k)}=ƒ(s(t), v(t), a(t)) where s(t) is vehicle position as s function of time, s(t) is vehicle position as s function of time, and a(t) is vehicle acceleration as s function of time. Additionally, the state space model may be defined in accordance with equation (6).

$$\dot{x} = [ \frac{1}{{m}_{e} ( \hat{ι} )} ( {ma}_{t} - {F}_{a} ( d ) - {F}_{r} ( s ) ) {τ}_{d}^{- 1} ( u - {a}_{t} ) ] \qquad ( 6 )$$

where:
mₑ(î) is equivalent mass including the powertrain inertia effects,
m is vehicle mass,
aₜ is vehicle acceleration,
Fₐ(d) is aerodynamic drag force as a function of vehicle distance to the front vehicle (d) if there is a front vehicle,
Fᵣ(s) is the rolling resistance force which depends on the position due to road grade and surface impacts,
τ_{d}⁻¹ is the inverse of a time constant selected to implement a first order lag effect, and
u is a tractive acceleration command.

Solver 410 may determine and output or otherwise provide vehicle k motion plan parameters 420 which may, in turn, be included in a transmission 422 to vehicle k+1. Solver 410 may determine and output or otherwise provide vehicle k capability parameters plan 425 which may, in turn, be included in a transmission 427 to vehicle k−1. Solver 410 may determine and output or otherwise provide vehicle k control parameters 430 which may, in turn, be included in a transmission 432 to other components or systems of vehicle k.

With reference to FIG. 5, there are illustrated example controls 450 which may be implemented or provided in one or more components of an electronic control system (ECS) of a vehicle, such as any or all of the ECS described in connection with FIGS. 1 and 2 or another ECS of a vehicle. It shall be appreciated that controls 450 are structural in nature in that they describe one or both of physical components and the configuration of physical components, such as code, data structures, executables, or instructions stored in non-transitory memory media.

Controls 450 include a combined motion planning solver 470 (also referred to herein as solver 470) which may be configured according to any of a number of model predictive controller (MPC) implementations and topologies as will occur to one of skill in the art with the benefit and insight of the present disclosure including, for example, linear, piecewise linear, non-linear, hybrid, adaptive, stochastic, machine learning-based MPC implementations and topologies. Solver 470 is configured to solve a combined motion planning problem for vehicle k and vehicle k+1 subject to vehicle k+1 capability parameters (if present, e.g., if a vehicle k+1 is present and communicating as expected) and vehicle k+1 motion plan parameters (if present, e.g., if a vehicle k−1 is present and communicating as expected).

Solver 470 may be configured to receive a plurality of inputs. In the illustrated example, solver 470 is configured to receive vehicle k capability parameters 462, vehicle k−1 capability parameters 464, look-ahead horizon parameters 466, and vehicle k+1 motion plan parameters 468, and may further be configured to receive a number of other parameters 469 as denoted by an ellipsis. Vehicle k capability parameters 462 may include, for example, current gear, velocity, distance from forward vehicle (if present), traction, mass, and engine power and torque limitations of vehicle k, as well as a number of other parameters pertaining to the capability of vehicle k. Vehicle k−1 capability parameters 464 may include, for example, current gear, velocity, distance from forward vehicle, traction, mass, and engine power and torque limitations of vehicle k, as well as a number of other parameters pertaining to the capability of vehicle k−1. Look-ahead horizon parameters 466 may include, for example, future or upcoming road grade, road direction or curvature, altitude, wind speed and direction, precipitation information, traffic flow information, and speed limit information, as well as a number of other a parameters as will occur to one of skill in the art with the benefit and insight of the present disclosure.

Vehicle k+1 motion plan parameters 408 may include, for example, recommended control or operation parameters for vehicle k, for example, acceleration, position, velocity, and/or other control or operation parameters. Such parameters may be configured in terms of objectives or results to be achieved (e.g., acceleration, position, velocity, and/or other conditions of vehicle k). Such parameters may also be configured in terms of commands or settings for particular components or systems of vehicle k (e.g., braking, powertrain, power, torque, or output, and/or other commands or settings).

In the illustrated example, solver 470 includes or utilizes a vehicle k cost function 472 which is a cost function established for a given vehicle k (e.g., the vehicle on or in connection with which controls 400 are implemented), and a vehicle k−1 cost function 474 which is a cost function established for a vehicle forward of vehicle k (e.g., the vehicle immediately forward of vehicle k). In other embodiments, solver 470 may include cost functions for other vehicles, or may vary the designation of a particular vehicle assigned to vehicle k−1 according to a formation or order of a current or anticipated vehicle platoon.

One or both of vehicle k cost function 472 and vehicle k−1 cost function 474 may be configured to account for a number of parameters relevant to vehicle motion planning. In one example embodiment, vehicle k cost function 472 and vehicle k−1 cost function 474 may be configured according to equation (1) above, but with modifications to substitute terms addressing vehicle k+1 with terms addressing vehicle k−1.

In the illustrated example, solver 470 includes or utilizes state constraints 476 which may be selected based on safety and speed limit or other regulatory or legal considerations. State constraints 476 may, for example, include the features and attributes of state constraints 416 described herein.

In the illustrated example, solver 470 includes optimization objectives and constraints 478 which defines an optimization objective and constraints on the optimization objective for which solver 470 determines a solution. Solver 470 may be configured to solve a joint optimization problem for vehicle k and vehicle k−1 which may be defined at least in part by optimization objectives and constraints 478. In performing such joint optimization, solver 470 may be configured to account for performance capability parameters of vehicle k and vehicle k+1. In one embodiment, optimization objectives and constraints 478 defines its optimization objective in accordance with equation (4), but with modifications to substitute terms addressing vehicle k+1 with terms addressing vehicle k−1, and defines its constraints in accordance with equations (5), but with modifications to substitute terms addressing vehicle k+1 with terms addressing vehicle k−1.

Optimization objectives and constraints 478 may define or model such parameters in a number of manners. For example, the admissible control set for vehicle k (U^{(k)}) and the admissible control set for vehicle k−1 (U^{(k-1)}) may be defined based on the maximum engine torque accounting for losses and gearing effects intermediate the engine and the wheels and further based on the maximum engine power. Furthermore, the state vector may be further defined as x^{(k)}=ƒ(s(t), v(t), a(t)) where s(t) is vehicle position as s function of time, s(t) is vehicle position as s function of time, and a(t) is vehicle acceleration as a function of time. Additionally, the state space model may be defined in accordance with equation (6).

Solver 470 may determine and output or otherwise provide vehicle k motion plan parameters 480 which may, in turn, be included in a transmission 482 to vehicle k−1. Solver 470 may determine and output or otherwise provide vehicle k capability parameters plan 485 which may, in turn, be included in a transmission 487 to vehicle k+i. Solver 470 may determine and output or otherwise provide vehicle k control parameters 490 which may, in turn, be included in a transmission 492 to other components or systems of vehicle k.

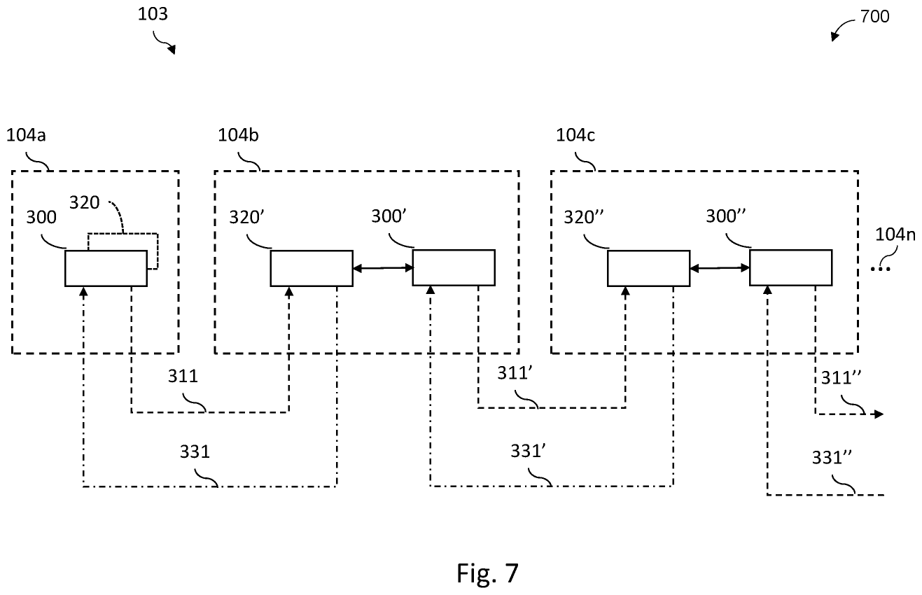

With reference to FIG. 7, there is illustrated and example system 700 including ECS 104a, 104b, 104c, 104n of vehicles 101a, 101b, 101c, 101n, ECS 104a is configured to execute or perform process 300 which is depicted in an operational state and process 320 which is depicted in a dormant or nonoperational state. ECS 104b is configured to execute or perform process 300′ which is analogous to process 300, but provided in a different vehicle, and process 320′ which is analogous to process 320 but provided in a different vehicle and also depicted in an operational state. ECS 104c is configured to execute or perform process 300″ which is analogous to process 300, but provided in a different vehicle, and process 320″ which is analogous to process 320 but provided in a different vehicle and also depicted in an operational state. The ECS of one or more additional vehicles 101n may be configured to execute similar corresponding processes.

The communication between the foregoing processes is further depicted in FIG. 7. In one aspect of the illustrated example, transmissions may be provided to immediately neighboring rearward vehicles and/or received from immediately neighboring forward vehicles. For example, process 300 may send transmission 311 to process 320′, process 300′ may send transmission 311′ to process 320″, and process 300″ may send transmission 311″ to a process of vehicle 101n which is not depicted. In another aspect of the illustrated example transmissions may be provided to immediately neighboring forward vehicles and/or received from immediately neighboring rearward vehicles. For example, process 320″ may send transmission 331′ to process 300′, process 320′ may send transmission 331 to process 300′, and another process (not depicted of vehicle 101n may send a transmission 331″ to process 300″. Furthermore, each pair of processes of a given ECS (processes 300 and 320 of ECS 104a, processes 300′ and 320′ of ECS 104b, processes 300″ and 320″ of ECS 104c, etc.) may be in communication with one another.

A number of example embodiment according to the present disclosure shall now be further elucidated. A first example embodiment is a method of controlling one or more vehicles of a platoon of vehicles, the method comprising: determining a joint optimization of operating parameters of a first vehicle of the platoon and a second vehicle of the platoon, the second vehicle being positioned one of forward of and rearward of the first vehicle, the operating parameters of the first vehicle including vehicle motion plan parameters for the first vehicle, the operating parameters of the second vehicle including suggested control actions for the second vehicle; wirelessly transmitting from the first vehicle the vehicle motion plan parameters for the first vehicle and the suggested control actions for the second vehicle; wirelessly receiving at the first vehicle following vehicle capability parameters indicating capability of the second vehicle; determining in response to the following vehicle capability parameters an updated joint optimization including updated vehicle motion plan parameters for the first vehicle; and controlling motion of the first vehicle in response to the updated vehicle motion plan parameters.

A second example embodiment includes the features of the first example embodiment, wherein the determining a joint optimization of operating parameters of a first vehicle of the platoon and a second vehicle of the platoon comprises: operating a model predictive controller to jointly minimize a first cost function for the first vehicle and a second cost function for the second vehicle subject to a first set of permissible commands or states for the first vehicle and second set of permissible commands or states for the second vehicle.

A third example embodiment includes the features of the second example embodiment, wherein one or both of the first cost function for the first vehicle and the second cost function for the second vehicle includes one or more of a vehicle velocity term, a vehicle position term, an inter-vehicle separation distance objective term, and a slack term effective to allow for variation in the inter-vehicle separation distance term.

A fourth example embodiment includes the features of the second example embodiment, wherein one or both of the first cost function for the first vehicle and the second cost function for the second vehicle includes a vehicle velocity term, a vehicle position term, an inter-vehicle separation distance objective term, and a slack term effective to allow for variation in the inter-vehicle separation distance term.

A fifth example embodiment includes the features of the first example embodiment, wherein the determining a joint optimization of operating parameters of a first vehicle of the platoon and a second vehicle of the platoon is subject to vehicle capability parameters of the second vehicle.

A sixth example embodiment includes the features of the first example embodiment, wherein the determining a joint optimization of operating parameters of a first vehicle of the platoon and a second vehicle of the platoon is subject to motion plan parameters of a third vehicle, the third vehicle being positioned the other of forward of and rearward of the first vehicle.

A seventh example embodiment includes the features of the first example embodiment, wherein the first vehicle is positioned one of immediately forward of and immediately rearward of the second vehicle.

A eighth example embodiment includes the features of the first example embodiment, wherein the following vehicle capability parameters include any one or more of: a current gear of the following vehicle, a current distance between the forward vehicle and the following vehicle, a current velocity of the following vehicle, a current traction of the following vehicle, engine power limitation of the following vehicle, and engine torque limitations of the following vehicle.

A ninth example embodiment includes the features of the first example embodiment, wherein the following vehicle capability parameters include: a current gear of the following vehicle, a current distance between the forward vehicle and the following vehicle, a current velocity of the following vehicle, a current traction of the following vehicle, engine power limitation of the following vehicle, and engine torque limitations of the following vehicle.

A tenth example embodiment includes the features of the first example embodiment, wherein the updated joint optimization further include suggested control actions for the second vehicle.

An eleventh example embodiment is a system for controlling one or more vehicles of a platoon of vehicles, the system comprising: an electronic control including one or more processors configured to execute instructions stored in one or more non-transitory memory media to: determine a joint optimization of operating parameters of a first vehicle of the platoon and a second vehicle of the platoon, the second vehicle being positioned one of forward of and rearward of the first vehicle, the operating parameters of the first vehicle including vehicle motion plan parameters for the first vehicle, the operating parameters of the second vehicle including suggested control actions for the second vehicle; wirelessly transmit from the first vehicle the vehicle motion plan parameters for the first vehicle and the suggested control actions for the second vehicle; wirelessly receive at the first vehicle following vehicle capability parameters indicating capability of the second vehicle; determine in response to the following vehicle capability parameters an updated joint optimization including updated vehicle motion plan parameters for the first vehicle; and control motion of the first vehicle in response to the updated vehicle motion plan parameters.

A twelfth example embodiment includes the features of the eleventh example embodiment, wherein the instructions to determine a joint optimization of operating parameters of a first vehicle of the platoon and a second vehicle of the platoon include: instructions to operate a model predictive controller to jointly minimize a first cost function for the first vehicle and a second cost function for the second vehicle subject to a first set of permissible commands or states for the first vehicle and second set of permissible commands or states for the second vehicle.

A thirteenth example embodiment includes the features of the twelfth example embodiment, wherein one or both of the first cost function for the first vehicle and the second cost function for the second vehicle includes one or more of a vehicle velocity term, a vehicle position term, an inter-vehicle separation distance objective term, and a slack term effective to allow for variation in the inter-vehicle separation distance term.

A fourteenth example embodiment includes the features of the twelfth example embodiment, wherein one or both of the first cost function for the first vehicle and the second cost function for the second vehicle includes a vehicle velocity term, a vehicle position term, an inter-vehicle separation distance objective term, and a slack term effective to allow for variation in the inter-vehicle separation distance term.

A fifteenth example embodiment includes the features of the eleventh example embodiment, wherein the instructions to determine a joint optimization of operating parameters of a first vehicle of the platoon and a second vehicle of the platoon are subject to vehicle capability parameters of the second vehicle.

A sixteenth example embodiment includes the features of the eleventh example embodiment, wherein the instructions to determine a joint optimization of operating parameters of a first vehicle of the platoon and a second vehicle of the platoon are subject to motion plan parameters of a third vehicle, the third vehicle being positioned the other of forward of and rearward of the first vehicle.

A seventeenth example embodiment includes the features of the eleventh example embodiment, wherein the first vehicle is positioned one of immediately forward of and immediately rearward of the second vehicle.

An eighteenth example embodiment includes the features of the eleventh example embodiment, wherein the following vehicle capability parameters include any one or more of: a current gear of the following vehicle, a current distance between the forward vehicle and the following vehicle, a current velocity of the following vehicle, a current traction of the following vehicle, engine power limitation of the following vehicle, and engine torque limitations of the following vehicle.

A nineteenth example embodiment includes the features of the eleventh example embodiment, wherein the following vehicle capability parameters include: a current gear of the following vehicle, a current distance between the forward vehicle and the following vehicle, a current velocity of the following vehicle, a current traction of the following vehicle, engine power limitation of the following vehicle, and engine torque limitations of the following vehicle.

A twentieth example embodiment includes the features of the eleventh example embodiment, wherein the updated joint optimization further include suggested control actions for the second vehicle.

While illustrative embodiments of the disclosure have been illustrated and described in detail in the drawings and foregoing description, the same is to be considered as illustrative and not restrictive in character, it being understood that only certain illustrative embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of controlling one or more vehicles of a platoon of vehicles, the method comprising:
determining a joint optimization of operating parameters of a first vehicle of the platoon and a second vehicle of the platoon, the second vehicle being positioned one of forward of and rearward of the first vehicle, the operating parameters of the first vehicle including vehicle motion plan parameters for the first vehicle, the operating parameters of the second vehicle including suggested control actions for the second vehicle;
wirelessly transmitting from the first vehicle the vehicle motion plan parameters for the first vehicle and the suggested control actions for the second vehicle;
wirelessly receiving at the first vehicle following vehicle capability parameters indicating capability of the second vehicle;
determining in response to the following vehicle capability parameters an updated joint optimization including updated vehicle motion plan parameters for the first vehicle; and
controlling motion of the first vehicle in response to the updated vehicle motion plan parameters.

2. The method of claim 1, wherein the determining a joint optimization of operating parameters of a first vehicle of the platoon and a second vehicle of the platoon comprises:
operating a model predictive controller to jointly minimize a first cost function for the first vehicle and a second cost function for the second vehicle subject to a first set of permissible commands or states for the first vehicle and second set of permissible commands or states for the second vehicle.

3. The method of claim 2, wherein one or both of the first cost function for the first vehicle and the second cost function for the second vehicle includes one or more of a vehicle velocity term, a vehicle position term, an inter-vehicle separation distance objective term, and a slack term effective to allow for variation in the inter-vehicle separation distance objective term.

4. The method of claim 2, wherein one or both of the first cost function for the first vehicle and the second cost function for the second vehicle includes a vehicle velocity term, a vehicle position term, an inter-vehicle separation distance objective term, and a slack term effective to allow for variation in the inter-vehicle separation distance objective term.

5. The method of claim 1, wherein the determining a joint optimization of operating parameters of a first vehicle of the platoon and a second vehicle of the platoon is subject to vehicle capability parameters of the second vehicle.

6. The method of claim 1, wherein the determining a joint optimization of operating parameters of a first vehicle of the platoon and a second vehicle of the platoon is subject to motion plan parameters of a third vehicle, the third vehicle being positioned the other of forward of and rearward of the first vehicle.

7. The method of claim 1, wherein the first vehicle is positioned one of immediately forward of and immediately rearward of the second vehicle.

8. The method of claim 1, wherein the following vehicle capability parameters include any one or more of:
a current gear of a following vehicle,
a current distance between a forward vehicle and the following vehicle,
a current velocity of the following vehicle,
a current traction of the following vehicle,
engine power limitation of the following vehicle, and
engine torque limitations of the following vehicle.

9. The method of claim 1, wherein the following vehicle capability parameters include:
a current gear of a following vehicle,
a current distance between a forward vehicle and the following vehicle,
a current velocity of the following vehicle,
a current traction of the following vehicle,
engine power limitation of the following vehicle, and
engine torque limitations of the following vehicle.

10. The method of claim 1, wherein the updated joint optimization further include suggested control actions for the second vehicle.

11. A system for controlling one or more vehicles of a platoon of vehicles, the system comprising:
an electronic control including one or more processors configured to execute instructions stored in one or more non-transitory memory media to:
determine a joint optimization of operating parameters of a first vehicle of the platoon and a second vehicle of the platoon, the second vehicle being positioned one of forward of and rearward of the first vehicle, the operating parameters of the first vehicle including vehicle motion plan parameters for the first vehicle, the operating parameters of the second vehicle including suggested control actions for the second vehicle;
wirelessly transmit from the first vehicle the vehicle motion plan parameters for the first vehicle and the suggested control actions for the second vehicle;
wirelessly receive at the first vehicle following vehicle capability parameters indicating capability of the second vehicle;
determine in response to the following vehicle capability parameters an updated joint optimization including updated vehicle motion plan parameters for the first vehicle; and
control motion of the first vehicle in response to the updated vehicle motion plan parameters.

12. The system of claim 11, wherein the instructions to determine a joint optimization of operating parameters of a first vehicle of the platoon and a second vehicle of the platoon include:
instructions to operate a model predictive controller to jointly minimize a first cost function for the first vehicle and a second cost function for the second vehicle subject to a first set of permissible commands or states for the first vehicle and second set of permissible commands or states for the second vehicle.

13. The system of claim 12, wherein one or both of the first cost function for the first vehicle and the second cost function for the second vehicle includes one or more of a vehicle velocity term, a vehicle position term, an inter-vehicle separation distance objective term, and a slack term effective to allow for variation in the inter-vehicle separation distance objective term.

14. The system of claim 12, wherein one or both of the first cost function for the first vehicle and the second cost function for the second vehicle includes a vehicle velocity term, a vehicle position term, an inter-vehicle separation distance objective term, and a slack term effective to allow for variation in the inter-vehicle separation distance objective term.

15. The system of claim 11, wherein the instructions to determine a joint optimization of operating parameters of a first vehicle of the platoon and a second vehicle of the platoon are subject to vehicle capability parameters of the second vehicle.

16. The system of claim 11, wherein the instructions to determine a joint optimization of operating parameters of a first vehicle of the platoon and a second vehicle of the platoon are subject to motion plan parameters of a third vehicle, the third vehicle being positioned the other of forward of and rearward of the first vehicle.

17. The system of claim 11, wherein the first vehicle is positioned one of immediately forward of and immediately rearward of the second vehicle.

18. The system of claim 11, wherein the following vehicle capability parameters include any one or more of:
a current gear of a following vehicle,
a current distance between a forward vehicle and the following vehicle,
a current velocity of the following vehicle,
a current traction of the following vehicle,
engine power limitation of the following vehicle, and
engine torque limitations of the following vehicle.

19. The system of claim 11, wherein the following vehicle capability parameters include:
a current gear of a following vehicle,
a current distance between a forward vehicle and the following vehicle,
a current velocity of the following vehicle,
a current traction of the following vehicle,
engine power limitation of the following vehicle, and
engine torque limitations of the following vehicle.

20. The system of claim 11, wherein the updated joint optimization further include suggested control actions for the second vehicle.
